(19) United States
(12) Patent Application Publication
(10) Pub. No.: US 2012/0002888 A1
(43) Pub. Date: Jan. 5, 2012

(54) Method and Apparatus for Automatic Pattern Analysis

(76) Inventor: Hiroshi Ishikawa, Fujimi (JP)

(21) Appl. No.: 13/230,838

(22) Filed: Sep. 12, 2011

Related U.S. Application Data
(63) Continuation of application No. 11/573,048, filed on Feb. 1, 2007.
(60) Provisional application No. 60/592,911, filed on Aug. 2, 2004.

(30) Foreign Application Priority Data
Aug. 1, 2005 (IB) PCT/IB05/52570

(51) Int. Cl. G06K 9/62

(52) U.S. Cl. 382/228

(57) ABSTRACT

A method and apparatus is disclosed for pattern analysis by arranging given data so that high-dimensional data can be more effectively analyzed. The method allows arrangements of given data so that patterns can be discovered within the data. By utilizing maps that characterizes the data and the type or the set it belongs to, the method produces many data items from relatively few input data items, thereby making it possible to apply statistical and other conventional data analysis methods. In the method, a set of maps from the data or part of the data is determined. Then, new maps are generated by combining existing maps or applying certain transformations on the maps. Next, the results of applying the maps to the data are examined for patterns. Optionally, certain strong patterns are chosen, idealized, and propagated backwards to find a data reflecting that pattern.

### CROSS-REFERENCE TO RELATED APPLICATIONS

This application is a continuation of application Ser. No. 11/573,048, filed Feb. 1, 2007, now pending, which is the National Stage of International Application No. PCT/IB2005/052570, filed Aug. 1, 2005, which claims the benefit of U.S. Provisional Application 60/592,911, filed Aug. 2, 2004. The patent application identified above is incorporated here by reference in its entirety to provide continuity of disclosure.

### TECHNICAL FIELD

The present invention relates to data analysis, and more specifically, a method and apparatus to arrange data so that patterns can be discovered.

### BACKGROUND ART

Data management, data processing, and data analysis have become ubiquitous factors in modern life and work. The development, management, and warehousing of enormous streams of data for scientific, medical, engineering, and commercial purposes have become a huge industry. Sources for biotech, financial, image, and other data, as well as demands for them are multiplying rapidly. Massive data are collected automatically, systematically obtaining many measurements, not necessarily knowing which ones will be relevant to the phenomenon of interest.

Thus it is increasingly important to find a needle in a haystack, teasing the relevant information out of a vast pile of data. This is significantly different from the old assumptions behind many of the techniques used in data analysis today. For many of those techniques, it is assumed that a few well-chosen variables are dealt with, for example, using scientific knowledge to measure just the right variables in advance.

The basic methodology that is used in the techniques no longer is always applicable. The theory underlying previous approaches to data analysis was based on the assumption that the number of data items is much larger than the dimension of the individual data. However, the dimension of the data is often much larger than the number of data items today. Such a case is no longer an anomaly but is in some sense the generic case. For many types of events, there are potentially very large number of measurable entities quantifying that event, and a relatively few instances of that event. One example is the case of the large number of genes and relatively few patients with a given genetic disease. Another example is the case of images: they can easily have a million dimensions (pixels), but a million images are rarely processed as a set of data to analyze.

### DISCLOSURE OF THE INVENTION

Accordingly, it is an object of the invention to provide a method and apparatus to arrange given data so that high-dimensional data can be more effectively analyzed. It is further object of the invention to provide a method to arrange given data in order to allow better pattern discovery within the data.

The method allows arrangements of given data so that patterns can be discovered within the data. By utilizing maps that characterizes the data and the type or the set it belongs to, the method produces many “data items” from relatively few input data items, thereby making it possible to apply statistical and other conventional data analysis methods. A set of maps from the data or part of the data is determined. Then, new maps are generated by combining existing maps or applying certain transformations on maps. Next, the results of applying the maps to the data are examined for patterns. For instance, in an embodiment of the invention, the frequency of particular resultant data or sets of data are examined. Optionally, certain strong patterns are chosen, idealized, and propagated backwards to find a data reflecting that pattern.

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

### Data

FIG. 1 shows a flow chart of the method to discover patterns in data. According to the method, a data to be analyzed is first received (101). The most common form of data is a series of bits, as used in the ubiquitous information processing systems and devices. The data usually has some structure and interpretation. For instance, some part of the data may be a text data, in which every group of 8-bits is interpreted as a character; some may represent 32-bit integers or 64-bit floating-point number. Or a single bit may have an interpretation in the data as “yes” or “no.” In a data representing a gene sequence, two bits may represent a base (one of A, G, C, T) in a nucleotide. The data may be divided into a number of records, each of which representing a set of information: an image data might consist of two integers specifying the number of pixels (width and height) and a series of integers representing the color of each pixel.

### Notation

Hereinafter, the data will be treated in a slightly more abstract manner. Integer numbers are called integers regardless of the number of bits it might be utilized to represent the number. Likewise, floating-point numbers are called real numbers and any data representing a choice between two alternatives, as in the case of “yes” or “no,” are called Booleans. More generally, various sets and maps are talked about in the following.

A set is a collection of members. For instance, the set Z of integers is a set that has all integers as its members. The set bool of Booleans has only two members, true and false. A set is sometimes denoted by enumerating all its members inside “{ },” as in boot={true, false}. The notation a c A means that a is a member of a set A. If all members of a set B are also members of another set A, B is a subset of A, which is denoted by A⊃B (or B⊂A.) Two sets A and B are equal (denoted A=B) if A⊃B and B⊃A. A subset B of A is a proper subset of A if A≠B.

The use of these notations does not imply that the method of present invention actually deals with the mathematical concept of sets. It is a way to describe the method in a concise and familiar notation for those skilled in the related art, where these notations are used to describe concepts, often not too rigorously. For instance, although some sets have infinitely many members as Z does, and some sets have members (such as real numbers) that need an infinite precision to be precisely specified, they are routinely handled on information systems, which is a finite entity. This is because usually only a finite number of members in such sets are necessary for the task at hand. Also, sometimes sets are processed symbolically; or, sometimes they are approximated. These and other techniques to represent and manipulate sets and maps are well known in the related art of Computer Science. Some programming languages such as SETL and MIRANDA even have sets as primitives. Also, the notion of sets and maps used herein is very close to the concept of types and maps in typed functional languages such as ML and HASKEL. One of ordinary skill in the related art will therefore be able to use appropriate techniques to realize the method that is to be disclosed.

For sets A and B, “A→B” denotes the set of maps from A to B. A map is a way of associating unique objects to every member in a given set. So a map from A to B is a function ƒ such that for every a in A, there is a unique object ƒ (a) in B. Such a situation is sometimes described as “ƒ sends (or maps) a to ƒ (a).” The notation “ƒ: A→B” means that ƒ is a map from set A to set B, i.e., f is a member of A→B. For a map ƒ: A→B, A is called the domain of ƒ.

For a set A, id_{A}: A→A denotes the identity map, which sends each member a of A to itself.

For sets A and B, the constant map const: A→(B→A) is defined by const(a)(b)=a, i.e., for a in A, const(a): B→A is a map that sends any b in B to a.

When B is a subset of A, inclusion map incl: B→A is defined by incl(b)=b.

For two sets A and B, A×B denotes a Cartesian product of the two sets, i.e., the set of ordered pairs (a, b) with a belonging to A and b to B. Similarly, A×B×C denotes a Cartesian product of the three sets A, B, and C, and so on. In general, a Cartesian product of arbitrary sets Aᵢ, indexed by another set I, is denoted by Π_{iεI}Aᵢ or, if all component sets Aᵢ are the same, by A^{I}. A member of Π_{iεI}Aᵢ is denoted by (aᵢ)_{iεI}, where each aᵢ is a member of Aᵢ. Let the standard sets with finite number of members be denoted thus: Z₁={1}, Z₂={1, 2}, . . . , Zₙ={1, . . . , n}. Hereinafter, A×B is to be understood as a shorthand for Π_{iεI}Aᵢ, with I=Z₂, A₁=A, and A₂=B. Similarly, A×B×C is a shorthand for Π_{iεI}Aᵢ with I=Z₃, A₁=A, A₂=B, and A₃=C, and so on.

A map ƒ: A→B is considered a member of the set B^{A}, the Cartesian product of the copies of B's indexed by A, by regarding the a′th component of ƒ as ƒ(a) for any aεA. Accordingly, A→B is considered an alias for B^{A} here.

A special set unit is defined. It has only one member. With unit, any member a of a set A can be considered a map a: unit→A that sends the single member of unit to a. The present invention may automatically perform this conversion in order to apply a map or operation that is only applicable to a map to an ordinary (non-map) member of a set. A set of the form A^{unit} or unit→A is identified with A.

For a map ƒ: A→B and a member b of B, the inverse image ƒ⁻¹(b) of b by ƒ is the subset of A that consists of the members of A that is sent to b by ƒ. An inverse image ƒ⁻¹(C) of a subset C of B by ƒ is the subset of A that consists of the members of A that is sent to a member of C by ƒ.

Some maps are defined recursively. That is, a recursively defined map uses itself in its definition. The factorial map fac: N→N, for instance, is defined as a map that sends a natural number n to: 1, if n=1; and n times fac(n−1), otherwise (here N denotes the set of natural numbers {1, 2, 3, . . . }.)

### Pullback

For two product sets Π_{iεI}Aᵢ and Π_{jεJ}Bⱼ, when there is a map h: J→I such that Aₕ₍ⱼ₎=Bⱼ for all jεJ, there is a corresponding pullback h*: Π_{iεI}Aᵢ→Π_{jεJ}Bⱼ defined by (h*((aᵢ)_{iεI}))ⱼaₕ₍ⱼ₎. Note the following special cases of this map.
[PB1] For any subset J of I, h*: Π_{iεI}Aᵢ→Π_{jεJ}Aⱼ with h=incl: J→I defines a projection map. For instance, for a Cartesian product A×B, there are natural projections:
   proj_{A}: A×B→A [proj_{A}(a, b)=a]
   proj_{B}: A×B→B [proj_{B}(a, b)=b]
The map proj_{A} is the same as h*: Π_{iεz}_{₂}Aᵢ→Π_{iεz}_{₁}Bⱼ with A₁=A, A₂=B, B₁=A, h=incl: Z₁→Z₂.
[PB2] For a Cartesian product A×A× . . . ×A of n copies of the same set, there is a diagonal map diag: A→A×A× . . . ×A defined by diag(a)=(a, a, . . . , a). This is the same as h*: Π_{iεz}_{₁}Aᵢ→Π_{jεz}_{ₙ}Bⱼ with A₁=A; Bⱼ=A, h: Zₙ→Z₁ defined by h(j)=1 for all j in Zₙ={1, . . . n}.
[PB3] For a Cartesian product A×B, there is a swap map A×B→B×A that sends (a, b) to (b, a). Similarly, for Cartesian products of any number of sets, there are permutation maps that change the order of the components. This is h*: Π_{iεz}_{ₙ}Aᵢ→Π_{jεz}_{ₙ}Bⱼ with h the permutation map and Bⱼ=Aₕ₍ⱼ₎ for all j in Zₙ={1, . . . , n}.
[PB4] For two maps ƒ: A→B and g: B→C, the concatenation map g∘ƒ: A→C is defined by g∘ƒ(a)=g(ƒ(a)) for a in A. This is also a special case of the pullback. To see this, remember gεC^{B}=Π_{bεB} C_{b} and g∘ƒεC^{A}=Π_{aεA} Cₐ with all C_{b} and Cₐ identical to C. Then ƒ*: Π_{bεB}C_{b}→Π_{aεA}Cₐ gives g∘ƒ=ƒ*(g).
[PB5] For sets A and B, and a in A, const(a): B→A is a map that sends any b in B to a. Consider a constant map const(a): J→A with J=Z₁ and its pullback const(a)*: Π_{iεA}B→Π_{jεJ}B. It maps a map ƒ: A→B to its value ƒ(a)εB at a. This defines a map that evaluates maps: ev: (A→B)×A→B defined by ev(ƒ, a)=ƒ(a).

### Statistics

In the present invention, representing data as statistics, such as a probability measure (probability distribution), or more generally, processing relative frequency of data, is especially useful. In general, for a set A, a probability measure Pr on A gives a real number Pr(B) between 0 and 1 for a subset (called an event) B of A. Representing data as a probability measure means the following: If any data is a singleton member a of a set A, it may be represented as a probability measure that gives Pr(B)=1 whenever an event B of A contains a and Pr(B)=0 otherwise; or it could be represented as an estimated measure such as a Gaussian distribution centered at a. If there are many data points that belong to the same set, it may be represented as a simple counting measure Pr(B) that gives the ratio of the data points contained in B relative to all the data points in A; or again as an estimated distribution such as Mixture of Gaussian or the one given by Parzen Window technique. For such handling or simulation of probability distribution on information systems, various techniques are well known in the related art. In an embodiment described later, one concrete method called the Frequency Count is used.

When using a probability measure in this way, a standard measure on each set is used as needed. This is a probability measure that represents the default state for the set, one with no characteristic, such as a uniform distribution.

### Primitive Maps

Next, a set of maps from the data or part of the data are determined (102). These maps are called primitive maps. A map included in the primitive maps might be one of standard maps defined on a set. For example, the set Z of integers has a map to itself that maps an integer to its successor. The set Z also has addition, which is expressed as a map from Z×Z to Z, and may be added to the set of primitive maps. Thus the addition map sends (i,j) in Z×Z to i+j in Z. Thus, if a part of the data represents one or more integers, a map that gives the successor of the integer or the sum of the integers might be included in the primitive maps. Some sets have natural maps between them. For instance, for any set A, the notion of equality defines a map from A×A to the Boolean set bool={true, false}, that is, for (u, v) in A×A the map gives true if and only if u=v. Similarly, some sets have the notion of order, which is considered a map, e.g., the set Z of integers are equipped with the ordering map from Z×Z to bool that, for (i,j) in Z×Z, gives true if and only if i<j.

The following lists some of the maps that come naturally with the sets and may be included in the set of primitive maps. Here, R denotes the set of real numbers.
[PM I] Any set A has the following primitive maps:
   Identity: id_{A}: A→A [id_{A}(a)=a]
   Constant: const: A→(B→A) [const(a)(b)=a] (for any set B)
[PM II] For a set A that equality can be easily determined, the equality map:
   eq_{A}: A×A→bool [eq_{A}(a, b)=true if a=b; false otherwise]
[PM III] From two maps ƒ: A→B and g: C→D, a product map ƒ×g: A×C→B×D is defined by ƒ×g((a, c))=(ƒ(a), g(c)). This defines a primitive map mp: (A→B)×(C→D)→(A×C→B×D).
[PM IV] The pullback operation on maps pullback: (J→I)→(Π_{iεI}Aᵢ→Π_{jεJ}Bⱼ). This sends a map to another map. Special cases include the projection maps [PB1], the diagonal maps [PB2], the permutation maps [PB3], the map-concatenation map [PB4], and the evaluation maps [PB5].
[PM V] Combining lower-order maps. Let K be an index set and Iₖ be index sets for each kεK. Assume that there are known maps ƒₖ: Π_{iεI}_{ₖ}A_{k, i}→Bₖ for kεK and another index set J with maps hₖ: Iₖ→J such that hₖ(i)≠hₘ(j) whenever A_{k, i}≠A_{m, j}. Define a map F: Π_{kεK}Π_{iεI}_{ₖ}A_{k, i}→Π_{kεK}Bₖ and h: L→J, where F is the product map of ƒₖ's for all k in K, L=∪_{kεK}Iₖ is the disjoint union of the index sets Iₖ's, and h is defined so that h equals hₖ on Iₖ. Then concatenating h*: Π_{jεJ}AⱼΠ_{kεK}Π_{iεI}_{ₖ}A_{k, i}, the pullback of h, and F defines a new map F∘h*: Π_{jεJ}Aⱼ→Π_{kεK}Bₖ.
[PM VI] The currying map curry: (A×B→C)→(A→(B→C)) sends a map ƒ: A×B→C to a map curry(ƒ): A→(B→C) that sends a in A to a map curry(ƒ)(a): B→C defined by curry(ƒ)(a)(b)=ƒ(a, b). The reverse operation is the uncurrying map uncurry: (A→(B→C))→(A×B→C) that sends a map g: A→(B→C) to another map uncurry(g): A×B→C that sends (a, b)εA×B to g(a)(b). This is well known in Computer Science.
[PM VII] There are various logical operations: NOT: bool→bool, AND: bool×bool→bool, OR: bool×bool→bool, etc.
[PM VIII] Any vector space V, including R, has the following natural maps:
   (Addition) Add_{V}: V×V→V [Add_{V}(u, v)=u+v]
   (Multiplication by a real number) Mult_{V}: R×V→V [Mult_{V} (a, v)=av]
   (Subtraction) Sub_{V}: V×V→V [Sub_{V} (u, v)=u−v] (although this may be defined by combining the addition and multiplication by −1, it is included here for later simplicity of notation.)
   (Length) Len_{V}: V→R [Len_{V}(v)=the length of vector v]
   Various linear transformations, parametrized by another vector space:
      LT: V×U→W
   Various linear, bilinear, trilinear, . . . etc. form, parametrized by another vector space:
      LF: V×U→R
      BF: V×V×U→R
      TF: V×V×V×U→R
[PM IX] R has the notion of order:
   Ord_{R}: R×R→bool [Ord_{R} (a, b)=true if a<b; false otherwise]
[PM X] The Euclidean space E has the notion of vectors between two points:
   Diff_{E}: E×E→V,
   where V is a vector space of the same dimension.
[PM XI] For certain set U of the real valued functions on a subset A of R (i.e., U is a subset of A→R,) the derivative map Der: U→(A→R) sends the functions to their derivatives (differentiations). There are similar maps that take various derivatives of maps between real vector spaces. More generally, there are other well-known mathematical transformations that may be put in as primitive maps (e.g., Fourier Transformation.)
[PM XII] Fixed point operation. For a map f: A→A, the fixed point operator Fix: (A→A)→A gives a fixed point of the map, i.e., a=Fix(ƒ) is a member of A such that ƒ(a)=a. This can be used to define a recursively defined map. For instance, the factorial map fac: N→N described above can be obtained from a non-recursive map. Let F: (N→N)→(N→N) be a map that sends a map ƒ: N→N to another map F(ƒ): N→N that sends a natural number n to: 1, if n=1; and n times ƒ(n−1), otherwise. Then, Fix(F) is the factorial map. Note that the fixed point operation may not be applicable to all maps.

A primitive map may also be more specific to the data that is represented. If an integer in the data represents the taxable income of a person, a map that gives the tax for that income might be included in the set of primitive maps, depending on the need of the application.

### Derived Data and Maps

In the next step (103), other data and maps are generated, based on the data and the primitive maps. Some of the ways of generating them are:
Two or more sets may be made into a product. Probability measures on the product set may be induced from those on the original sets.
Data may be sent by a map. A probability measure may be induced by a map.
An inverse image by a map of a set may be taken.
Data may be restricted to a subset. A probability measure may be restricted to a subset.
A map that sends a map to another map may be applied to create a new map, including:
   From two maps ƒ: A→B and g: C→D, a product map ƒ×g: A×C→B×D is defined by (ƒ×g) ((a, z))=(ƒ(a), g(z)) (see [PM III].)
   From two maps ƒ: A→B and g: B→C, a map g◯ƒ: A→C is defined by (g∘ƒ) (a)=g(ƒ(a)) for a in A (see [PM IV].)
   A higher order map, i.e., a map with more arguments, is important because it defines a relation between many objects. Combining maps to derive higher order maps is especially important, since most of primitive maps have at most two arguments. Thus the primitive map in [PM V] is important. Although it is a special case of the application of maps on maps mentioned above, it merits spelling out with an example here: Let ƒ: A×A→B be a map. To make a higher order map, first a product map is made: ƒ×ƒ: A×A×A×A→B×B. But this map does not give much new information, as it is just doing the same operation twice. However, g: A×A×A→B×B defined by g(a, b, c)=ƒ×ƒ(a, b, b, c) defines a new relation between the three arguments. This is what is done in this case when the primitive map in [PM V] is applied.

There are many ways of choosing from the methods and sources such as listed above for generating new data and maps at various stages of the method. There should be a scheme to choose the data and map to be created so as to better the likelihood of finding useful patterns, depending on the application and the data and the maps already found. Generally, maps that have been deemed pattern maps (see below) should have higher tendency to be used as the components of new maps. Also, sets that some patterns have been found in should be used more frequently as the source set. One way used in an embodiment of the invention is described later.

### Patterns

In the next step (104), the existence of any pattern is examined within the various data and maps that are generated. This is done using any of the conventional techniques of discovering patterns, such as finding a repeated data, pursuing statistically significant conditions such as low entropy of a probability measure, or detecting concentration of probability on relatively few members. Such data in which a pattern has been found is called a pattern data hereinafter.

Note that the pattern data are result of applying some map to the original and generated data. These maps are hereinafter called the pattern maps. Pattern maps are important for pattern analysis. For instance, if the result of applying a map to a data is approximately a repeated pattern, or if induced probability measure from a probability measure by a map has low entropy, these maps characterize the original data in some aspect. Pattern maps would be useful to apply to other similar data to examine for the same characteristics. Combination of various pattern maps can characterize the data in the original and various intermediate sets.

In determining the presence of a pattern, the one that comes from the map itself must be taken into account. That is, if the map itself always creates the pattern, the pattern does not represent any characteristic of the data. For instance, the entropy mentioned above has to be evaluated relative to that of the result of applying the same pattern map to something that does not have any pattern, e.g., the standard probability measure on the domain set of the pattern map.

### Backtrack

Optionally, in the next step (105), the method may take a pattern data that is found in the previous steps and generate an “ideal” data that corresponds to the pattern. First, a new data may be created in the same set (as the set in which a pattern data is found) by modifying the pattern data. If the pattern data was identified as a probability measure with low entropy on a generated set, an idealized probability measure with even lower entropy may be introduced on the set; and probability measures that, through the pattern map, induce the idealized measure may be found. If a concentration of probability is observed, the idealization may concentrate it more; also, if there are relatively few concentrations, multiple probability measures may be created as a new pattern data, each with a single concentration. An approximately repeated pattern may be made an exactly repeated pattern.

Then the inverse image of the idealized patterns by the corresponding pattern maps may be taken. A set of possible data in the intermediate sets all the way back to the set the original data was in are thus identified. This may be implemented by creating a predicate on the sets that gives true for a data whenever the data is sent by the pattern map to reside in the idealized pattern. Also, the part of original data that resides in this set (i.e., the part that is given true by the corresponding predicate) is especially important, as this partial data may be then sent forward by other maps to see if any other pattern emerges.

A set of possible data with the pattern can be thus identified. Using sufficiently many patterns and taking the intersection of such inverse images, a small set of possible data or even a single datum may be found.

### Output

In the next step (106), any data that is desired are output. This may include the patterns that are found and “pure” data that correspond to the patterns.

Finally, a halt condition for the process is examined (107) and the process repeats if the condition is not met.

### BRIEF DESCRIPTION OF DRAWINGS

FIG. 1 shows a flow chart of the method to discover patterns in data.

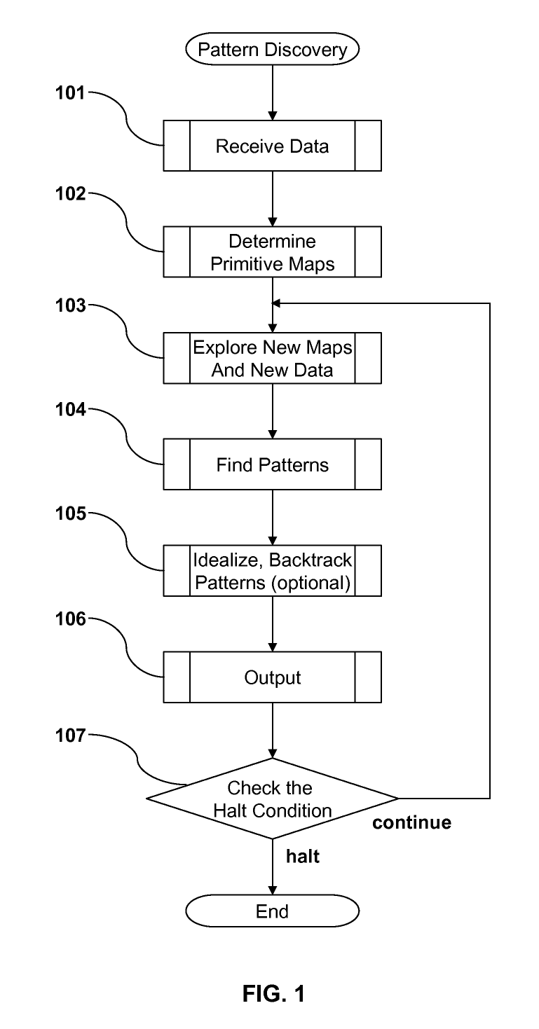

FIG. 2 shows the flowchart of the exploration algorithm.

FIG. 3 schematically shows the data structure FC and substructures used in FC.

FIG. 4 shows the flowchart of the process of idealization.

### BEST MODE FOR CARRYING OUT THE INVENTION

In the following description, for purposes of explanation, numerous specific details are set forth in order to provide a thorough understanding of the present invention. It may be evident, however, to one skilled in the art that the present invention may be practiced without these specific details. In other instances, well-known structures and devices are shown in block diagram form in order to facilitate description of the present invention. It is to be understood that the present invention may be implemented in various forms of hardware, software, firmware, special purpose processors, or a combination thereof. Preferably, the present invention is implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device. It is to be further understood that, because some of the constituent system components and method steps depicted in the accompanying Figures are preferably implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Here, an embodiment of the present invention to analyze data is presented. For clarity's sake, a level of abstraction is maintained that is common and well-known to those skilled in the related art; for instance, sets and maps are represented as, or approximated by, data on an information system.

### Data

To illustrate how frequency or probability is handled in the present invention, a data structure called frequency count is herein disclosed. It is a concrete way to model the simple counting probability measures on a set. In this embodiment, all data is represented as a frequency count on some set.

In the following, for any set A, a frequency count on A means a data that keeps track of members of A and their numbers. It is treated as a subset of A×N, where N={1, 2, 3, . . . } is the set of natural numbers, such that no member of A appears more than once. The set of frequency counts on A is denoted by Freq(A). Thus a frequency count on A, i.e., a member F of Freq(A), is a set of pairs (a, n), where a is a member of A and n is a natural number, such that if (a, n) is in F, no other member of the form (a, m) is in F. These pairs in frequency counts are hereinafter called the particles. For a member a of A and a frequency count F on A, the count of a, denoted by count_{F}(a), is defined to be n, if there is a particle of the form (a, n) in F, and 0 otherwise; mass(F), the mass of F, is defined by the sum of count_{F}(a) for all a in A; and P_{F}(a), the probability of a, is defined by count_{F}(a) divided by mass(F). The support supp(F) of F is defined to be the subset of A that consists of the members a with count_{F}(a)>0. The entropy H(F) of F is defined by the sum −Σ_{aεsupp(F)}P_{F}(a) log₂P_{F}(a) for all a in supp(F).

The following should be noted for later reference:
[FC I] From two frequency counts F on A and G on B, another frequency count (the product) F×G on A×B may be generated as follows: F×G is a subset of (A×B)×N that consists of particles ((a, b), nm) for all combinations of particles (a, n) in F and (b, m) in G. This corresponds to the product probability measure.
[FC II] When there is a map f. A→B, a map ƒ_{*}: Freq(A)→Freq(B) of frequency counts is defined as follows: For a frequency count F, ƒ_{*}(F) is a subset of B×N that consists of particles (b, n) such that at least one particle (a, m) in F with b=ƒ(a) exists and n is the sum of m's in all such particles (a, m). In other words, the set ƒ_{*}(F) is made by adding (ƒ(a), m) for all (a, m) in F and then replacing (b, i) and (b,j) of the same b by (b, i+j) until there is no distinct particles that have the same first component. This corresponds to the induced probability measure.
[FC III] If A⊃B, then Freq(A)⊃Freq(B), i.e., a frequency count on B is automatically a frequency count on A. When A⊃B and F is a frequency count on A, the restriction F|_{B} of F to B is a frequency count on B (and therefore on A) that consists of all the particles (a, n) in F such that a is in B.
[FC IV] Two frequency counts F and G on A are said to be equivalent if there is a number m >0 such that count_{F}(a)=m count_{G}(a) for all a in A. If F and G are equivalent, various properties hold: mass(F)=m mass(G), supp(F)=supp(G), P_{F}(a)=P_{G}(a) for all a in A, and H(F)=H(G).
[FC V] For a set A, the standard frequency count St(A) on A is defined as the subset of A×N consisting of one particle (a, 1) for each a in A. Note that, according to this definition and [FC I], St(A)×St(B) is identical to St(A×B).

### Primitive Maps

All the primitive maps that are listed in [PM I] and on are included in the set of primitive maps.

### Derived Data and Maps

Based on the loaded data and the primitive maps, other data and maps are generated to explore the possibilities of various sets that characterize the data. In the beginning, there is the input data represented as a frequency count on sets. Thus the system begins by trying possible maps that can be applied to the sets. The result of applying such maps to existing data is a new data. More specifically, the process keeps the following data structures:
A data structure FC that stores a representation of frequency counts. It begins with the input data represented as frequency counts; and the standard frequency count St(A) (see [FC V]) for any set A that appears as a component of the set which the input data is on (i.e., if the input data is a frequency count on A×(B→C), the standard frequency counts on A, B, C, B→C, and A×(B→C) would be in FC.) It also includes the standard frequency counts on some standard sets such as bool and unit.
A data structure SETS that stores the symbolic representations of sets. It begins with the sets the frequency counts in FC are on.
A data structure MAPS that stores the symbolic representations of maps. It begins with the primitive maps in it.

As the process continues, more members are added to FC, SETS and MAPS, in one of the following way:
[D I] If a pair of frequency counts F and G are already in FC, F×G may be added to FC (see [FC I].) Similarly for three or more frequency counts.
[D II] If any map in MAPS can be applied to some map(s) in MAPS (e.g., [PM III], [PM IV], [PM V], [PM VI], and [PM XII]) the resulting map may be added to MAPS. For instance, some pair of maps may be chosen and either their product or, if applicable, their concatenation may be added to MAPS; or it may be any map applied to other maps and result may be added to MAPS.
[D III] A subset of a set in SETS can be added to SETS. A frequency count may be restricted to a subset. An inverse image of a subset can be added to SETS. For a subset B of A, the subset classifier map subset_{B}: A→bool (defined by subset_{B}(a)=true if aεB and false otherwise) may be added to MAPS.
[D IV] If a frequency count F on a set A is in FC and a map f: A→B is in MAPS, ƒ_{*}(F) may be added to FC (see [FC II].) If this rule is used to add a frequency count, FC also records the map that was used.

Note that the sets can be considered to make a directed graph structure by taking sets as nodes and maps as edges. The frequency counts on the sets can also be considered to make a directed graph structure by taking frequency counts as nodes and maps as edges.

These maps and data can be explored and added to the data structures in various orders. For instance, a breadth-first search order could be used in the tree structure mentioned above. In this embodiment, a stochastic search algorithm is used:

### Exploration Algorithm

### Outline

Stochastically execute one of the actions from 1 to 6 below:
1. Choose a pair of frequency counts F and Gin FC and add F×G to FC. Add A×B to SETS, where A and B are the sets F and G are on, respectively.
2. Choose and apply a map in MAPS that can be applied to map(s) according to [D II], add the result to MAPS.
3. Choose a set in A in SETS, add a proper subset B of A to SETS and add subset_{B}: A→bool to MAPS.
4. Choose in FC a frequency count F. Choose a proper subset B of A in SETS, where A is the set F is on. Add F|_{B} to FC.
5. Choose a map f: A→B in MAPS and a proper subset C of B in SETS. Add the inverse image ƒ⁻¹(C) to SETS.
6. Choose a frequency count F in FC and a map fin MAPS from the set that F is on to some other set. Add ƒ_{*}(F) to FC.

### Details

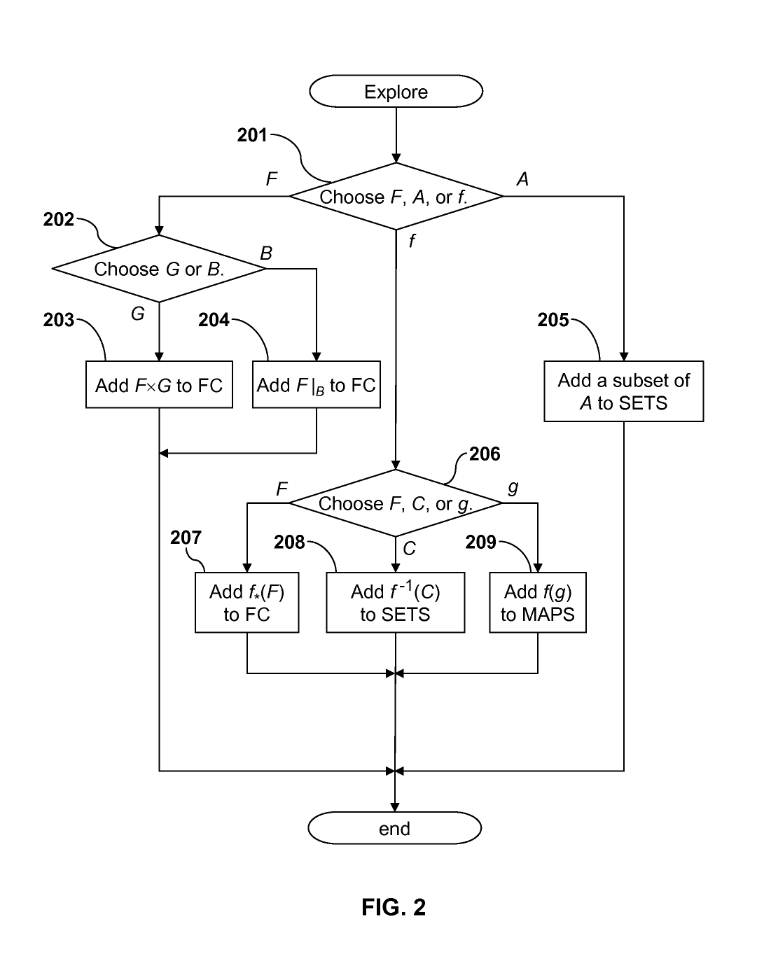

FIG. 2 shows the flowchart of the exploration algorithm. The choice of the action taken and the choice of the objects of the action are done stochastically.

Each frequency count, set, and map in FC, SETS, and MAPS is assigned an integral weight. In the beginning, the input data has the weight 1000, others are all given the weight of 100.

For each frequency count or map, a set of eligible objects are defined as follows: For a frequency count F on a set A, its set EO(F) of eligible objects consists of all the frequency counts in FC and all proper subsets of A in SETS. For a map ƒ: A→B, its set EO(ƒ) of eligible objects consists of all maps in MAPS to which ƒ can be applied, all proper subsets of B in SETS, and all frequency counts on A.

Each time the exploration algorithm is invoked, a frequency count, a set, or a map is chosen with a probability from FC, SETS, and MAPS (201). The probability is proportional to its weight; except in the case of a set, where it is proportional to 200 divided by the number of members in the set.

If a frequency count F on a set A is chosen, another frequency count G or a proper subset B of A is chosen from EO(F) with a probability proportional to its weight (202). If G on a set C is chosen, F×G is added to FC and A×C to SETS (203). F×G is given the weight equal to the larger of the weights of F and G. A×C is given the weight equal to the larger of the weights of A and C. If B is chosen, F|_{B} is added to FC (204) and given the weight equal to the larger of the weights of F and B.

If a set A is chosen, its subset B is randomly chosen and added to SETS and given the weight of 100. The subset map subset_{B}: A→bool is also added to MAPS with the weight of 100 (205).

If a map ƒ: A→B is chosen, a frequency count F on A, a proper subset C of B, or a map g is chosen from EO(ƒ) with a probability proportional to its weight (206). If a frequency count F is chosen, ƒ_{*}(F) is added to FC (207), and given a weight equal to the larger of the weights of ƒ and F. If a proper subset C of B is chosen, ƒ⁻¹(C) is added to SETS (208) and given the same weight as C; if a map g is chosen, ƒ(g) is added to MAPS (209), and given the weight equal to the larger of the weights of ƒ and g.

### Particle Record

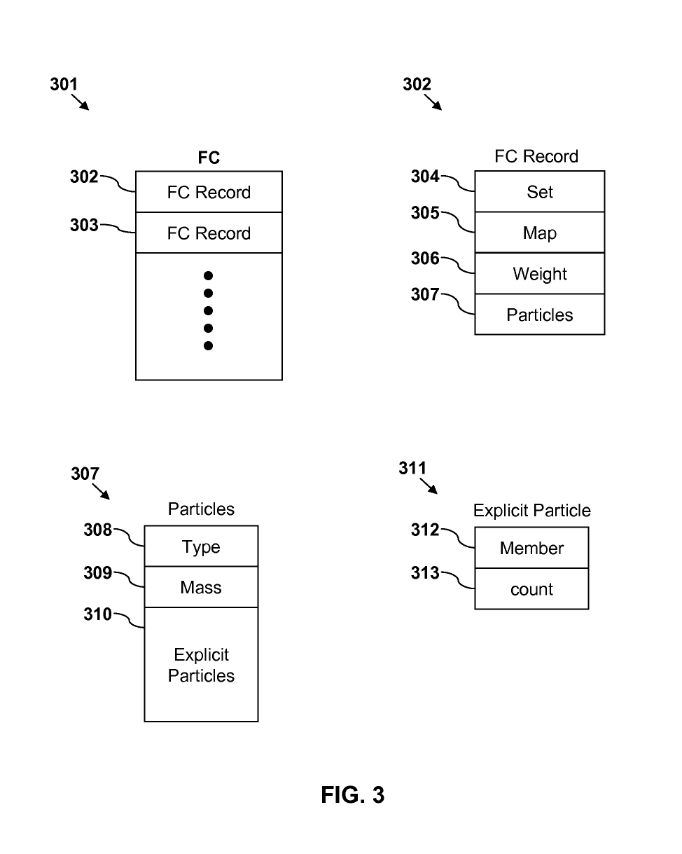

FIG. 3 schematically shows the data structure FC and the substructures used in FC. The data structure FC (301) contains a record for each frequency count (302, 303). The record (302) for a frequency count F on a set A contains the information on A (304), the map, the idealization (see below,) or the restriction to a subset that caused F (305), the weight w(F) (an integer) for F (306), and information on the particles in F (307). The particles record (307) keeps track of the particles, stochastically estimating if necessary. It contains the type of the particles record (308), the mass of F (309), and a data structure that stores explicit records of particles (310). The type of the particles record (308) has one of the values: standard, product, or explicit. For a standard frequency count on a set, the particles record has the type standard. For a product frequency count, the type is product. For these types of particles, no explicit record of the particles is kept, since any information can be readily obtained from the definition of these frequency counts. Otherwise, the particles record has the type explicit. This type of particles record stores explicit records of the particles. For a particle (a, n) in a frequency count F on a set A, where a is a member of A and n >0 is an integer, the explicit record for the particle (311) stores a and n in the fields member (312) and count (313), respectively. A constant MAXPARTICLE is used below. Though it should be determined according to factors such as the kind of input data and the available resources, MAXPARTICLE=100000 is given here for the sake of concreteness.

When the input data is received and represented as a frequency count, it creates a particle record (311) for each particle in the frequency count and stores it in the particles record (310); the type (308) is set to explicit. The sum of the count field (313) of the particles that are in the particles record (310) is stored in the mass field (309).

When a result of applying a map ƒ to a frequency count F on a set A is added to FC, in the record (302) that is created in FC for the result, the type is set to explicit. If the number of particles in F is more than MAXPARTICLE, only MAXPARTICLE particles are stochastically chosen with the probability proportional to their count; otherwise, all particles in F are chosen. For each chosen particle (a, n), the member ƒ(a) is computed. If an explicit particle record (311) with the member field (312) containing ƒ(a) is already there, its count field (313) is increased by n; otherwise, an explicit particle record (311) is created with the member field (312) containing ƒ(a) and the count field (313) set to n.

### Patterns

In this embodiment, the method iterates the Exploration Algorithm and then checks for patterns (data and map) in the frequency counts in FC. This is done by calculating the entropy H(F) for any frequency count F that has been updated in the current iteration, if any. The entropy is normalized by subtracting it from the entropy of the frequency count that is created by sending, by the same map that created F, the standard frequency count on the original set. Thus, if a frequency count F on A is created by sending the frequency count G on B, by a map ƒ: B→A, i.e., F=ƒ_{*}(G), the quantity J(ƒ, F)=H(ƒ_{*}(St(B)))−H(F) is computed. When a frequency count with J(ƒ, F) higher than a threshold value is found, the map ƒ and the frequency count that led to the frequency count is marked as pattern and used (e.g., output, backtracked) in the later stages; also the map and the frequency count each gets its weight value increased by 100. The threshold value should be determined according to the application and other factors, such as the available resources. As the benchmark of the presence of patterns other than J(ƒ, F), another possibility is the relative entropy (also known as Kullback-Leibler divergence). For two frequency counts F and G, the relative entropy D(F, G) is the sum of −P_{F}(a) log₂[P_{F}(a)/P_{G}(a)] for all a in supp(G). Instead of finding a high J(ƒ, F), a low D(F,ƒ_{*}(St(B))) may be looked for.

In computing the entropy of various frequency counts, various relationships are employed to reduce the computation cost:
For evaluation map ev: (A→B)×A→B, the frequency count ev_{*}(St(A→B)×St(A)) is equivalent to St(B), thus H(ev_{*}(St(A→B)×St(A)))=H(St(B)). This is important for efficiency since sets of maps tend to be large.
For any frequency counts F and G, H(F×G)=H(F)+H(G).
For any frequency counts F on A and G on B, and maps ƒ: A→B and g: C→D, it holds (ƒ×g)_{*}(F×G)=ƒ_{*}(F)×g_{*}(G), thus H((ƒ×g)_{*}(F×G))=H(ƒ_{*}(F))+H(g_{*}(G)).
For a projection map proj_{A}: A×B→A and frequency counts F on A and G on B, proj_{A*}(F×G) is equivalent to F. Thus H(proj_{A*}(F×G))=H(F).
For an injection ƒ: A→B, i.e., a map ƒ such that ƒ(a)≠ƒ(b) implies a≠b, and a frequency count F on A, it holds H(ƒ_{*}(F))=H(F).

### Backtrack

When a frequency count F with low entropy is found, a process of idealization takes place.

That is a process of creating another frequency count F′ by removing some particles from F so that its entropy would be even lower.

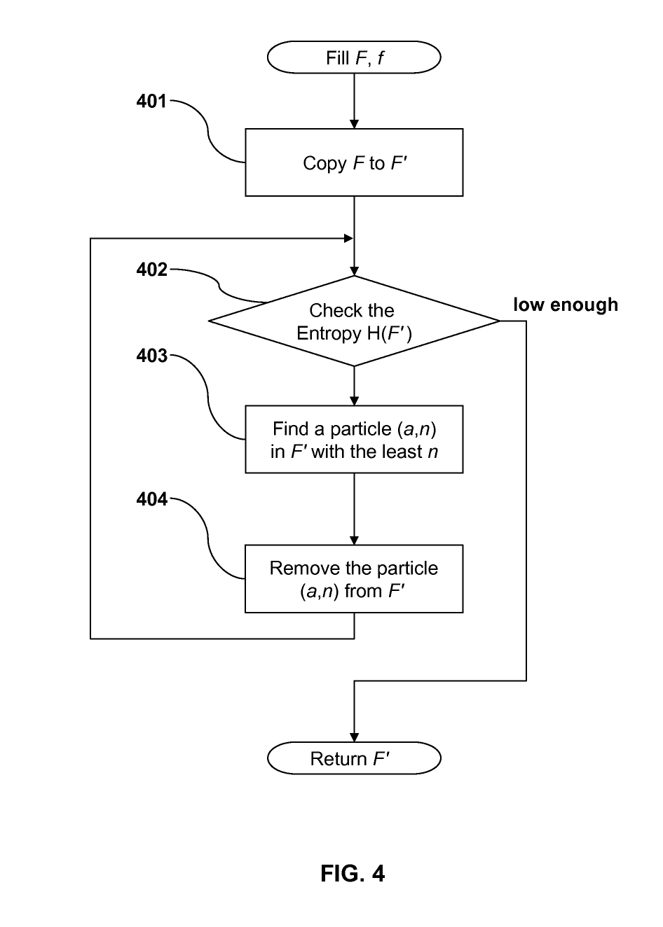

FIG. 4 shows the flowchart of the process of idealization. It takes a frequency count F and returns the idealized frequency count F′. First (401), F is copied to a new frequency count F′. Then, in a loop, the entropy of F′ is computed (402) and if it is lower than a predetermined value, the process terminates and returns F′ as a return value. Otherwise, a particle (a, n) in F′ with the lowest count n is found in F′ (403) and removed (404). Then the loop returns to 402. The predetermined value of entropy should be determined according to the application.

Next, the particles still left in F′ are backtracked. Let the map that caused F be ƒ. A→B, i.e., F=ƒ_{*}(G) for some frequency count G on a set A. A particle (b, n) in F′ is made by combining the particles of the form (ƒ(a), mₐ) (see [FC II].) Let θ_{*}⁻¹(F′) be the inverse image of F′ by ƒ, which is the restriction of G to ƒ⁻¹(supp(F′)) (see [FC III].) That is, (a, m) in G belongs to ƒ_{*}⁻¹(F′) if and only if count_{F′}(ƒ(a))>0. If ƒ has been made by concatenating more than one map, e.g., ƒ=ƒ₁◯ƒ₂∘ . . . ∘ƒₖ, there will be a series of frequency counts such as ƒ_{k*}⁻¹(F′), (ƒₖ₋₁∘ƒₖ)_{*}⁻¹(F′), and so on. These frequency counts are added to FC along with the information as to how they are created (e.g., the idealization, the taking of inverse image) and the same weight as that of F. They are then treated in the same way as other frequency counts in FC.

Finally, if a frequency count F in FC is on a set of maps, i.e., a set that is of the form A→B for some sets A and B, and if relatively few members of the set have higher counts, one of more members of A→B with high counts may be added to MAPS.

### Output

The maps that were found as patterns may be used as indicators of useful characteristics or parameters of the original data. As such, they are the output of the embodiment. The part of the data that causes a specific map to be a pattern is found by backtracking and may also be output.

### EXAMPLES

This embodiment can be used to analyze various kinds of data. The following examples are intended to illustrate but not limit the use to which this embodiment may be put.

### Example 1

### Image

### Data

In this embodiment, an image is loaded from any of available image file format and represented in the following way.

The color space is denoted by Col. For a color image, it is generally a three dimensional real vector space. If the image is a grayscale image, Col is the set of real numbers. For images with larger spectrum Col might be a vector space of higher dimensions. Here, the only assumption is that it is a real vector space.

The image domain is denoted by Dom and assumed to be some finite subset of a d-dimensional Euclidean space E_{Dom}. For instance, an ordinary bitmap image has a domain of m×n lattice points in a 2-dimensional Euclidean space. For other kind of images, such as 3D medical image data, the dimension would be higher.

An image generally gives colors at each point in the domain. Thus an image can be considered a map from Dom to Col, that is, a member of the set Dom→Col. This embodiment represents the input image by a frequency count on Dom→Col. That is, the initial data is a frequency count Im in Freq(Dom→Col) that contains one particle (im, 1), where im: Dom→Col is the map that sends each pixel position to the color in the image.

### Primitive Maps

In addition to the general primitive maps, there may be added primitive maps specifically useful for image data. For instance, if the image is in pixels, as usually the case, neighbor relationship between pixels may be useful. This is put in the system as a primitive map Nb: Dom×Dom→bool that gives true whenever two members of Dom are neighboring pixels. Another example would be various kinds of filters that are known in the related art of image processing; e.g., a wavelet filter.

### Derived Data and Maps

Some examples of simpler maps and data that the method may add to MAPS and FC are:

A. Color Frequency
A1. By [D I], a frequency count Im×St(Dom) on (Dom→Col)×Dom is added to FC, based on the two frequency counts, Im on Dom→Col and St(Dom) on Dom.
A2. By [D IV], ev_{*}(Im×St(Dom)) is added to FC based on Im×St(Dom) from A1 and the evaluation map ev_{*}(Dom→Col)×Dom→Col (which, as a primitive map, is in MAPS.)

The frequency count ev_{*}(Im×St(Dom)) on Col is a set of particles (c, n_{c}), where n_{c} is the number of pixels that has color c.

B. Color Difference and Position Difference Frequency
B1. By [D II], a map (mp∘diag)×diag: (Dom→Col)×(Dom×Dom)→(Dom×Dom→Col×Col)×(Dom×Dom)×(Dom×Dom) is added to MAPS, based on the diagonal map diag: (Dom→Col)→(Dom→Col)×(Dom→Col), the product map mp: (Dom→Col)×(Dom→Col)→(Dom×Dom→Col×Col) and the diagonal map diag: Dom×Dom→(Dom×Dom)×(Dom×Dom).
B2. By [D II], a map ev×id_{Dom×Dom}: (Dom×Dom→Col×Col)×(Dom×Dom)×(Dom×Dom)→(Col×Col)×(Dom×Dom) is added to MAPS, based on the evaluation map ev: (Dom×Dom→Col×Col)×(Dom×Dom)→Col×Col and the identity map on Dom×Dom.
B3. By [D II], a map Sub_{Col}×Diff_{Dom}: (Col×Col)×(Dom×Dom)→Col X V_{Dom} is added to MAPS, based on the subtraction in the color space and the difference map in the image domain.
B4. Concatenating the three maps added to MAPS in B1, B2, and B3, (Sub_{Col}×Diff_{Dom})∘(ev×id_{Dom×Dom})∘((mp∘diag)×diag): (Dom→Col)×(Dom×Dom)→Col×V_{Dom} is added to MAPS by [D II].
B5. By [D I], a frequency count Im×St(Dom×Dom) on (Dom→Col)×(Dom×Dom) is added to FC.
B6. By [D IV], the result of applying the map in B4 to the frequency count Im×St(Dom×Dom) added in B5 is added to FC.

The frequency count added in B6 on Col×V_{Dom} is a set of particles ((d, v), n_{d,v}), where n_{d,v} is the number of occurrence of pairs of pixels i) that have the color difference d, and ii) the vectors in the image domain between which is v.

### Patterns

The frequency count ev_{*}(Im×St(Dom)) on Col obtained in A2 would have small entropy when there are not too many colors used. If the whole image is one color, it would have entropy of 0, the lowest possible value.

The frequency count added in B6 on Col×V_{Dom} would have small entropy when there are many pairs of pixels that have the same particular color difference and are separated by the same vector. If, for instance, there are horizontal lines of one color, there would be relatively high concentration of particles (particles with high counts) with color difference 0 and horizontal vectors, giving the frequency count lower entropy.

### Example 2

### Data Matrix

A data matrix is a rectangular array with N rows and D columns, the rows giving different observations or individuals and the columns giving different attributes or variables. Each variable can have a value that is a member of some set, which we call here the value set. For instance, if the variable can only take an integral number, the value set is the set of integers. If the variable can take any number, the value set is the set of real numbers. Or if the variable can take the value of “yes” or “no”, the value set can be the set of Booleans.

Let the D variables denoted by a₁, a₂, . . . , a_{D} and the sets in which variables take values by X₁, X₂, . . . , X_{D}, respectively. Then, each observation gives a member in the set X₁×X₂× . . . ×X_{D}. The input data in the form of a data matrix is represented in this embodiment as a frequency count on X₁×X₂× . . . ×X_{D} with each observation contributing a single count in one particle. Thus, the mass of the frequency count is N.

### INDUSTRIAL APPLICABILITY

Thus a method and apparatus has been disclosed to arrange given data so that high-dimensional data can be more effectively analyzed and better pattern discovery within the data is allowed. It is applicable in wide variety of industry, where more and more data are collected and it is increasingly important to find the relevant information out of a vast pile of data. The areas in which the present invention is useful includes the case of the large number of genes and relatively few patients with a given genetic disease and the case of images, which can easily have a million dimensions (pixels).

While only certain preferred features of the invention have been illustrated and described herein, many modifications and changes will occur to those skilled in the art. For instance, the concepts such as sets and maps, which have been used herein to explain the present invention has many equivalent or similar concepts in diverse discipline: e.g., function, type, method, etc. The terminologies such as set and map can be avoided entirely if one wishes; the whole invention can be described in terms of data and subroutine. Such superficial differences are, however, not real differences.

It is, therefore, to be understood that the appended claims are intended to cover all such modifications and changes and differences of terminologies as fall within the true spirit of the invention.

I claim:

1. A method of pattern analysis being executable by a processing arrangement of a computer platform comprising means to hold at least one data structure, said method comprising the steps of:
receiving at least one data to be analyzed;
storing said at least one data to be analyzed in said at least one data structure;
determining at least one primitive map according to said at least one data to be analyzed;
storing said at least one primitive map in said at least one data structure;
choosing, from a plurality of procedures, at least one procedure for deriving at least one other data, said plurality of procedures comprising:
a first procedure wherein at least one first data and at least one first map stored in said at least one data structure are chosen, and said at least one first map is applied to said at least one first data to derive said at least one other data; and
a second procedure wherein at least one second data stored in said at least one data structure is chosen, at least one Cartesian product of a plurality of sets represented in said at least one second data is taken, and said at least one Cartesian product is represented in said at least one other data;
deriving said at least one other data according to said at least one procedure; and
storing said at least one other data in said at least one data structure.

2. The method of claim 1, wherein said plurality of procedures further comprise:
a third procedure wherein at least one third data and at least one second map stored in said at least one data structure are chosen, at least one inverse image of at least one first set represented in said at least one third data by said at least one second map is taken, and said at least one inverse image is represented in said at least one other data.

3. The method of claim 2, wherein said plurality of procedures further comprise:
a fourth procedure wherein at least one fourth data stored in said at least one data structure is chosen, at least one subset of at least one second set represented in said at least one fourth data is taken, and said at least one subset is represented in said at least one other data.

4. The method of claim 3, further comprising the steps of:
seeking at least one first pattern within at least one fifth data stored in said at least one data structure;
storing said at least one first pattern in said at least one data structure if said at least one first pattern is found;
repeating a series of steps until at least one predetermined criterion is met, said series of steps comprising said choosing, deriving, storing other data, seeking, and storing first pattern steps; and
providing at least one second pattern stored in said at least one data structure as the result of pattern analysis of said at least one data to be analyzed, when said at least one predetermined criterion is met.

5. The method of claim 4, further comprising, after said storing first pattern step, the step comprising:
idealization step comprising generating at least one ideal data corresponding to said at least one first pattern if said at least one first pattern is found;
and wherein said series of steps further comprises said idealization step.

6. The method of claim 5, wherein said idealization step includes at least one of:
representing said at least one fifth data as at least one first probability measure, creating at least one second probability measure with lower entropy from said at least one first probability measure, and representing said at least one second probability measure in said at least one ideal data; and
representing said at least one fifth data as at least one third probability measure, concentrating said at least one third probability measure to create at least one fourth probability measure, and representing said at least one fourth probability measure in said at least one ideal data; and
representing said at least one fifth data as at least one fifth probability measure, creating a plurality of probability measures each of which corresponding to at least one concentration in said at least one fifth probability measure, and representing said plurality of probability measures in said at least one ideal data; and
making at least one approximately repeating pattern in said at least one fifth data repeat more exactly in said at least one ideal data.

7. The method of claim 6, further comprising, after said idealization step, the step comprising:
determining at least one pattern map corresponding to said at least one first pattern if said at least one first pattern is found;
and wherein said series of steps further comprises said determining pattern map step.

8. The method of claim 7, further comprising, after said determining pattern map step, the steps comprising:
backtrack step comprising taking the inverse image of said at least one ideal data by said at least one pattern map if said at least one first pattern is found;
and wherein said series of steps further comprises said backtrack step.

9. The method of claim 8, wherein said at least one primitive map comprises at least one of:
a product map,
a map that gives the product map of a plurality of maps,
a pullback-operation map,
a projection map,
a diagonal map,
a permutation map,
a map-concatenation map,
an evaluation map,
a map that combines a plurality of lower-order maps to give a higher-order map,
a currying map,
a logical-operation map,
a vector-operation map,
an order map,
a functional-operation map, and
a fixed-point-operation map.

10. The method of claim 1, further comprising the steps of:
seeking at least one first pattern within at least one fifth data stored in said at least one data structure;
storing said at least one first pattern in said at least one data structure if said at least one first pattern is found;
repeating a series of steps until at least one predetermined criterion is met, said series of steps comprising said choosing, deriving, storing other data, seeking, and storing first pattern steps; and
providing at least one second pattern stored in said at least one data structure as the result of pattern analysis of said at least one data to be analyzed, when said at least one predetermined criterion is met.

11. The method of claim 10, further comprising, after said storing first pattern step, the step comprising:
idealization step comprising generating at least one ideal data corresponding to said at least one first pattern if said at least one first pattern is found,
said idealization step including at least one of:
representing said at least one fifth data as at least one first probability measure, creating at least one second probability measure with lower entropy from said at least one first probability measure, and representing said at least one second probability measure in said at least one ideal data; and
representing said at least one fifth data as at least one third probability measure, concentrating said at least one third probability measure to create at least one fourth probability measure, and representing said at least one fourth probability measure in said at least one ideal data; and
representing said at least one fifth data as at least one fifth probability measure, creating a plurality of probability measures each of which corresponding to at least one concentration in said at least one fifth probability measure, and representing said plurality of probability measures in said at least one ideal data; and
making at least one approximately repeating pattern in said at least one fifth data repeat more exactly in said at least one ideal data;
and wherein said series of steps further comprises said idealization step.

12. The method of claim 11, further comprising, after said idealization step, the steps comprising:
determining at least one pattern map corresponding to said at least one first pattern if said at least one first pattern is found; and
backtrack step comprising taking the inverse image of said at least one ideal data by said at least one pattern map if said at least one first pattern is found;
and wherein said series of steps further comprises said determining pattern map step and said backtrack step.

13. The method of claim 12, wherein said at least one primitive map comprises at least one of:
a product map,
a map that gives the product map of a plurality of maps,
a pullback-operation map,
a projection map,
a diagonal map,
a permutation map,
a map-concatenation map,
an evaluation map,
a map that combines a plurality of lower-order maps to give a higher-order map,
a currying map,
a logical-operation map,
a vector-operation map,
an order map,
a functional-operation map, and
a fixed-point-operation map.

14. A system for pattern analysis, said system comprising:
a program storage device including thereon a computer program;
means to hold at least one data structure; and
a processing arrangement which, when executing said computer program, is configured to follow the steps comprising:
receiving at least one data to be analyzed;
storing said at least one data to be analyzed in said at least one data structure;
determining at least one primitive map according to said at least one data to be analyzed;
storing said at least one primitive map in said at least one data structure;
choosing, from a plurality of procedures, at least one procedure for deriving at least one other data, said plurality of procedures comprising:
a first procedure wherein at least one first data and at least one first map stored in said at least one data structure are chosen, and said at least one first map is applied to said at least one first data to derive said at least one other data; and
a second procedure wherein at least one second data stored in said at least one data structure is chosen, at least one Cartesian product of a plurality of sets represented in said at least one second data is taken, and said at least one Cartesian product is represented in said at least one other data;
deriving said at least one other data according to said at least one procedure; and
storing said at least one other data in said at least one data structure.

15. The system of claim 14, wherein said plurality of procedures further comprise:
a third procedure wherein at least one third data and at least one second map stored in said at least one data structure are chosen, at least one inverse image of at least one first set represented in said at least one third data by said at least one second map is taken, and said at least one inverse image is represented in said at least one other data; and
a fourth procedure wherein at least one fourth data stored in said at least one data structure is chosen, at least one subset of at least one second set represented in said at least one fourth data is taken, and said at least one subset is represented in said at least one other data;
and wherein said processing arrangement, when executing said computer program, is configured to follow the further steps comprising:
seeking at least one first pattern within at least one fifth data stored in said at least one data structure;
storing said at least one first pattern in said at least one data structure if said at least one first pattern is found;
repeating a series of steps until at least one predetermined criterion is met, said series of steps comprising said choosing, deriving, storing other data, seeking, and storing first pattern steps; and
providing at least one second pattern stored in said at least one data structure as the result of pattern analysis of said at least one data to be analyzed, when said at least one predetermined criterion is met.

16. The system of claim 15, wherein said processing arrangement, when executing said computer program, is configured to further follow, after said storing first pattern step, the step comprising:
idealization step comprising generating at least one ideal data corresponding to said at least one first pattern if said at least one first pattern is found,
said idealization step including at least one of:
representing said at least one fifth data as at least one first probability measure, creating at least one second probability measure with lower entropy from said at least one first probability measure, and representing said at least one second probability measure in said at least one ideal data; and
representing said at least one fifth data as at least one third probability measure, concentrating said at least one third probability measure to create at least one fourth probability measure, and representing said at least one fourth probability measure in said at least one ideal data; and
representing said at least one fifth data as at least one fifth probability measure, creating a plurality of probability measures each of which corresponding to at least one concentration in said at least one fifth probability measure, and
representing said plurality of probability measures in said at least one ideal data; and
making at least one approximately repeating pattern in said at least one fifth data repeat more exactly in said at least one ideal data;
and wherein said series of steps further comprises said idealization step.

17. The system of claim 16, wherein said processing arrangement, when executing said computer program, is configured to follow, after said idealization step, the further steps comprising:
determining at least one pattern map corresponding to said at least one first pattern if said at least one first pattern is found; and
backtrack step comprising taking the inverse image of said at least one ideal data by said at least one pattern map if said at least one first pattern is found;
and wherein said series of steps further comprises said determining pattern map step and said backtrack step;
and wherein said at least one primitive map comprises at least one of:
an identity map,
a constant map,
an equality map,
a product map,
a map that gives the product map of a plurality of maps,
a pullback-operation map,
a projection map,
a diagonal map,
a permutation map,
a map-concatenation map,
an evaluation map,
a map that combines a plurality of lower-order maps to give a higher-order map,
a currying map,
a logical-operation map,
a vector-operation map,
an order map,
a functional-operation map, and
a fixed-point-operation map.

18. A non-transitory software storage medium which, when executed by a processing arrangement of a computer platform comprising means to hold at least one data structure, is configured to perform pattern analysis, said software storage medium comprising at least one application program which, when executed, causes said processing arrangement to follow the steps comprising:
receiving at least one data to be analyzed;
storing said at least one data to be analyzed in said at least one data structure;
determining at least one primitive map according to said at least one data to be analyzed;
storing said at least one primitive map in said at least one data structure;
choosing, from a plurality of procedures, at least one procedure for deriving at least one other data, said plurality of procedures comprising:
a first procedure wherein at least one first data and at least one first map stored in said at least one data structure are chosen, and said at least one first map is applied to said at least one first data to derive said at least one other data; and
a second procedure wherein at least one second data stored in said at least one data structure is chosen, at least one Cartesian product of a plurality of sets represented in said at least one second data is taken, and said at least one Cartesian product is represented in said at least one other data;
deriving said at least one other data according to said at least one procedure; and
storing said at least one other data in said at least one data structure.

19. The non-transitory software storage medium of claim 18, wherein said plurality of procedures further comprise:
a third procedure wherein at least one third data and at least one second map stored in said at least one data structure are chosen, at least one inverse image of at least one first set represented in said at least one third data by said at least one second map is taken, and said at least one inverse image is represented in said at least one other data; and
a fourth procedure wherein at least one fourth data stored in said at least one data structure is chosen, at least one subset of at least one second set represented in said at least one fourth data is taken, and said at least one subset is represented in said at least one other data;
and wherein said at least one application program, when executed, causes said processing arrangement to follow the further steps comprising:
seeking at least one first pattern within at least one fifth data stored in said at least one data structure;
storing said at least one first pattern in said at least one data structure if said at least one first pattern is found;
repeating a series of steps until at least one predetermined criterion is met, said series of steps comprising said choosing, deriving, storing other data, seeking, and storing first pattern steps; and
providing at least one second pattern stored in said at least one data structure as the result of pattern analysis of said at least one data to be analyzed, when said at least one predetermined criterion is met.

20. The non-transitory software storage medium of claim 19, wherein said at least one application program, when executed, causes said processing arrangement to further follow, after said storing first pattern step, the steps comprising:
idealization step comprising generating at least one ideal data corresponding to said at least one first pattern if said at least one first pattern is found;
determining at least one pattern map corresponding to said at least one first pattern if said at least one first pattern is found; and
backtrack step comprising taking the inverse image of said at least one ideal data by said at least one pattern map if said at least one first pattern is found;
and wherein said series of steps further comprises said idealization step, said determining pattern map step, and said backtrack step.
